(19) United States
(12) Patent Application Publication
(10) Pub. No.: US 2006/0140081 A1
(43) Pub. Date: Jun. 29, 2006

(54) Information storage medium having flexibility for allocating an area, recording method, reproducing method and apparatus thereof

(75) Inventors: Sung-hee Hwang, Seoul (KR); Kyung-geun Lee, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/022,880

(22) Filed: Dec. 28, 2004

(51) Int. Cl. G11B 19/02; G11B 20/10; G11B 15/52; G11B 5/09

(52) U.S. Cl. 369/47.1

(57) ABSTRACT

An information storage medium having flexibility of allocating an area, a recording method, a reproducing method, and an apparatus thereof. The method to obtain flexibility of allocating areas on a disc includes: recording on the disc, location information to recognize each area disposed on the disc. According to the method, the disc drive is able to recognize areas disposed on discs with different formats and a variety of different area boundaries.

### BACKGROUND OF THE INVENTION

1. Field of the Invention

The present invention relates to an information storage medium having flexibility of allocating an area, a recording method, a reproducing method, and an apparatus thereof.

2. Description of the Related Art

On an information storage medium, there are a variety of areas distinguished physically or logically. For example, a disc such as a CD or a DVD has a lead-in area, a data area, and a lead-out area. The boundaries of these areas are usually distinguished by physical location information on a disc. That is, the specification of a CD or a DVD describes address information distinguishing each area of the disc. A disc drive manufacturer produces a disc drive by referring to address information specified in the specification such that each area can be recognized.

However, if a new area not specified by the specification is allocated, or the location of an existing area is changed from that specified in the specification, a disc drive that can recognize only existing areas complying with the specification cannot recognize that the location of the existing area is changed, as well as the fact that the new area is allocated. Accordingly, the disc drive cannot correctly record information on the disc on which the new area is allocated, and cannot read information already recorded.

In DVD-RAM physical specification version 2.0, in order to indicate the size and location of a supplementary spare area, a secondary defect list (SDL) that is an information structure indicating the location where a defect occurs has a field, “start sector number of supplementary spare area”. Since a disc drive manufactured based on the specification already knows physical address information corresponding to the end of the supplementary spare area and at the same time the end of a data area, the size and location of the supplementary spare area can be indicated only by the “start sector number of supplementary spare area”. The size and location information on a primary spare area is specified only in a specification. A disc drive manufacturer designs and manufactures a disc drive according to the location information recorded in the specification.

When other areas are desired to be additionally allocated depending on necessity, if other areas are specifically allocated 1) between the lead-in area and the primary spare area, 2) between the primary spare area and a user data area, 3) between the user data area and the supplementary spare area, or 4) between the supplementary spare area and the lead-out area, the boundaries between the existing spare areas and the user data area will be changed, but a disc drive for an existing DVD-RAM will not be able to recognize the changed boundaries such that a problem in recording and reproducing data will occur. That is, if a disc on which a new area is defined or the location of an existing area is changed is developed, there will be a problem of compatibility with the conventional discs.

### SUMMARY OF THE INVENTION

In accordance with an aspect of the present invention, an information storage medium having flexible area allocation, in which compatibility between information storage media having different boundaries of allocated areas, or having at least one area with different boundaries, can be maintained, a recording method, a reproducing method, and an apparatus thereof are provided.

According to an aspect of the present invention, there is provided a method to obtain flexibility of allocating an area on a disc including: recording on the disc, location information to recognize each area disposed on the disc.

In an aspect of the present invention, in recording of the location information, location information to recognize each of a user data area and a spare area disposed on the disc is recorded, and the location information is recorded in at least one of the lead-in area and lead-out area. In another aspect of the present invention, the location information is recorded in a defect management area disposed in at least one of the lead-in area or lead-out area.

According to another aspect of the present invention, there is provided a method to obtain flexibility of allocating an area on a disc including: reading from the disc, location information of each area disposed on the disc; and recognizing each area disposed on the disc based on only the read location information.

In an aspect of the present invention, reading the location information includes reading location information of a user data area and a spare area disposed on the disc.

In an aspect of the present invention, the method further includes: allocating a new area; and recording the location information of the allocated new area on the disc.

In an aspect of the present invention, the method further includes: when the location of an existing area is changed, recording the changed location information again on the disc.

According to another aspect of the present invention, there is provided an apparatus including: a writing/reading unit recording data on or reading data from a disc; and a control unit controlling the writing/reading unit such that location information to recognize each of a lead-in area, a user data area, a spare area, and a lead-out area disposed on the disc is recorded on the disc.

In an aspect of the present invention, the control unit controls the writing/reading unit such that the location information is recorded in at least one of the lead-in area or the lead-out area.

In an aspect of the present invention, the control unit controls the writing/reading unit such that the location information is recorded in a defect management area.

According to another aspect of the present invention, there is provided an apparatus including: a writing/reading reading unit reading location information of each area disposed on a disc, from the disc; and a control unit recognizing each area disposed on the disc based on only the read location information.

In an aspect of the present invention, the control unit controls the writing/reading unit such that location information to recognize each of a user data area and a spare area disposed on the disc is read from the disc.

In an aspect of the present invention, the control unit controls the writing/reading unit such that when a new area is allocated, the location information of the allocated new area is recorded on the disc.

In an aspect of the present invention, the control unit controls the writing/reading unit such that when a temporary defect management area is allocated, the location information of the allocated temporary defect management area is recorded on the disc.

According to a further aspect of the present invention, there is provided a single recording layer disc in which a lead-in area, a data area and a lead-out area are disposed and in the data area, at least one spare area and a user data area are disposed, wherein in at least one of the lead-in area, the data area, or the lead-out area, location information to recognize each of the spare area and the user data area is recorded, and a disc drive recognizes the spare area and the user data area by referring to only the location information.

According to an additional aspect of the present invention, there is provided a disc having double recording layers, including a first recording layer in which a lead-in area, a data area having at least one spare area disposed, and an outer area are disposed, and a second recording layer in which an outer area, a data area having at least one spare area disposed, and a lead-out area are disposed, wherein in at least one of the lead-in area, the lead-out area or the outer area, location information to recognize each of the spare area and a user data area is recorded, and a disc drive recognizes the spare and the user data area by referring to only the location information.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an apparatus according to an embodiment of the present invention;

FIG. 2 is a block diagram of a disc drive in which the apparatus of FIG. 1 is implemented;

FIGS. 3A and 3B illustrate structures of a single recording layer disc according to an embodiment of the present invention;

FIGS. 4A through 4F illustrate implementation examples of the disc of FIGS. 3A and 3B, and are reference diagrams showing a variety of cases in which a new area is allocated;

FIGS. 5A and 5B illustrate structures of a double recording layer disc according to an embodiment of the present invention;

FIGS. 6A and 6B illustrate implementation examples of the disc of FIGS. 5A and 5B, and are reference diagrams showing a variety of cases in which a new area is allocated;

FIG. 7 illustrates the data structure in a temporary defect management area according to an embodiment of the present invention;

FIG. 8 is a reference diagram explaining in detail a process for recording data in a user data area and a spare area according to an embodiment of the present invention; and

FIG. 9 is a flowchart of the steps performed by a method to obtain flexibility according to an embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention, by referring to the figures.

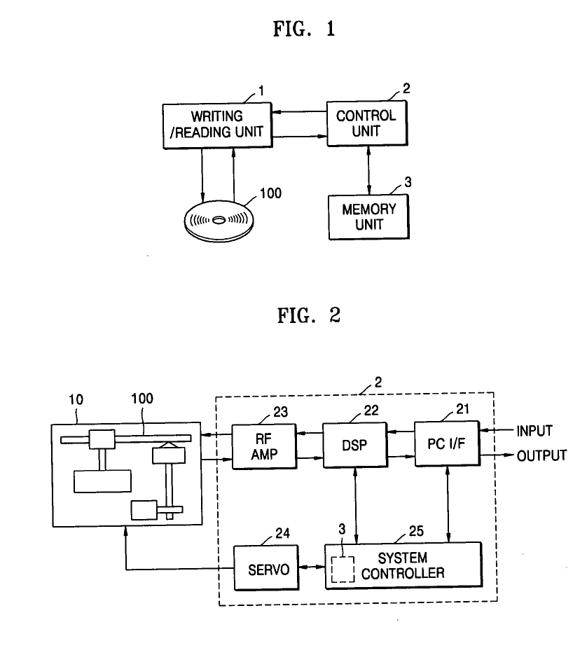

Referring FIG. 1, an apparatus according to an embodiment of the present invention includes a writing/reading unit 1, a control unit 2, and a memory unit 3. The writing/reading unit 1 records data on a disc 100 and/or reads data recorded on the disc 100. In order to obtain flexibility of allocating an area on the disc 100 according to aspects of the present invention, the control unit 2 reads location information of each area recorded on the disc 100 and based on the location information, recognizes the boundaries of each area. Also, the control unit 2 allocates a new area on the disc 100 according to the selection of a user or a predetermined condition, and if the newly allocated area changes the location of an existing area, records the changed location information on the disc 100. The disc 100 is an information storage medium such as a CD, DVD or HD-DVD.

The control unit 2 performs defect management according to a verify after write method, by which the control unit 2 allocates a temporary defect management area on the disc, records data in predetermined units by using the allocated temporary defect management area, and then, by verifying the recorded data, finds a unit in which a defect occurs. The control unit 2 records user data in predetermined units and then, verifies the user data. By doing so, the control unit 2 checks where a defective area occurs. The control unit 2 generates defect information indicating where the defective area found as a result of the checking is located. The control unit 2 stores the generated defect information in the memory unit 3, collects a predetermined amount of the defect information, and records the collected defect information on a temporary defect management area allocated on the disc 100. The information recorded in the temporary defect management area is referred to as temporary management information corresponding to management information for managing a defect recorded in a defect management area.

If the user finishes recording predetermined data and in order to unload the disc 100 pushes the eject button (not shown) disposed on the apparatus, the control unit 2 expects that one recording operation will come to an end. If the recording operation is expected to end, the control unit 2 reads the defect information stored in the memory unit 3, provides the information to the writing/reading unit 1, and commands the writing/reading unit 1 to record the information in a different temporary defect management area.

When recording data on the disc 100 is finished, that is, when no more data is desired to be recorded on the disc 100 (i.e., when finalizing is performed), the control unit records temporary management information, which is recorded on the disc 100, in a defect management area disposed on the disc 100.

Generally, a defect management area allocated on a disc is not very large. In particular, in a write once disc, repetitive recording is impossible and therefore it is difficult to record all defect information occurring until finalizing is performed, in a defect management area. Accordingly, in aspects of the present invention if the disc 100 is a write once disc, a new area that has not been in the conventional disc (i.e., a temporary defect management area) is separately allocated and defect management is performed, then when finalizing is performed, only a final version of the defect information is recorded in the defect management area. In addition, location information on the newly allocated area and location information of a changed area (i.e., an existing area that had at least one of its boundaries changed by the new area allocation) are recorded together. Thus, even when a new area is allocated, the changed location information when the boundary of an existing area is changed, as well as the location of the new area is recorded on the disc 100 such that the disc drive is able to recognize each area correctly. That is, since the disc drive according to an embodiment of the present invention is able to recognize each area correctly based on the location information recorded or updated on the disc 100, compatibility between discs having different areas or different allocations of the same areas, and furthermore, compatibility between a write once disc and a rewritable disc can be maintained.

FIG. 2 is a block diagram of a disc drive in which the apparatus of FIG. 1 is implemented.

Referring to FIG. 2, the disc drive includes a pickup 10 as the writing/reading unit 1. The disc 100 is placed on the pickup 10. Also, the disc drive has a PC I/F 21, a DSP 22, an RF amp 23, a servo 24, and a system controller 25 as the control unit 25. The memory unit 3 is disposed in the system controller 25 of the control unit 2. It is understood that the memory unit 3 may be located separate from the control unit 2 in other aspects of the present invention.

When data is recorded, the PC I/F 21 receives data to be recorded and a write command from a host (not shown). The system controller 25 performs initialization required for recording data. The DSP 22 adds additional data such as a parity for error correction to data which is received from the PC I/F 21 and to be recorded, performs ECC encoding, and modulates the ECC encoded data in a predetermined method. The RF amp 23 converts the data output from the DSP 22 into an RF signal. The pickup 10 records the RF signal output from the RF amp 23 on the disc 100. The servo 24 receives a command input required for servo control from the system controller 25 and servo controls the pickup 10. Also, when data is recorded, the system controller 25 reads location information on allocated areas disposed on the disc 100 according to aspects of the present invention, and based on the read location information, recognizes each area. In addition, when a new area is allocated, new location information of the new area and the location information on areas whose boundaries are changed are updated.

Furthermore, according to an embodiment of the present embodiment, in order to perform defect management according to the selection of the user, or a predetermined condition, the system controller 25 commands the pickup 10 to read data recorded on the disc 100 or to record predetermined information such as temporary management information.

When data is reproduced, the PC I/F 21 receives a read command from a host (not shown). The system controller 25 performs initialization required for reproducing data. At this time, according to the location information of each area recorded on the disc 100 according to the present invention, each area is recognized. The pickup 10 irradiates a laser beam on the disc 100, and outputs an optical signal obtained by receiving the laser beam reflected from the disc 100. The RF amp 23 converts the optical signal output from the pickup 10 into an RF signal, provides modulated data obtained from the RF signal to the DSP 22, while providing a servo signal for control obtained from the RF signal to the servo 24. The DSP 22 outputs location information obtained by demodulating the modulated data or outputs data obtained through ECC error correction. Meanwhile, the servo 24 receives the servo signal from the RF amp 23 and a command required for servo control from the system controller 25, and performs servo control of the pickup 10. The PC I/F 21 transmits data received from the DSP 22 to the host. Also, when data is reproduced, the system controller 25 can command the pickup 10 to read information required for defect management. That is, the system controller 25 manages the entire system when data is recorded or reproduced.

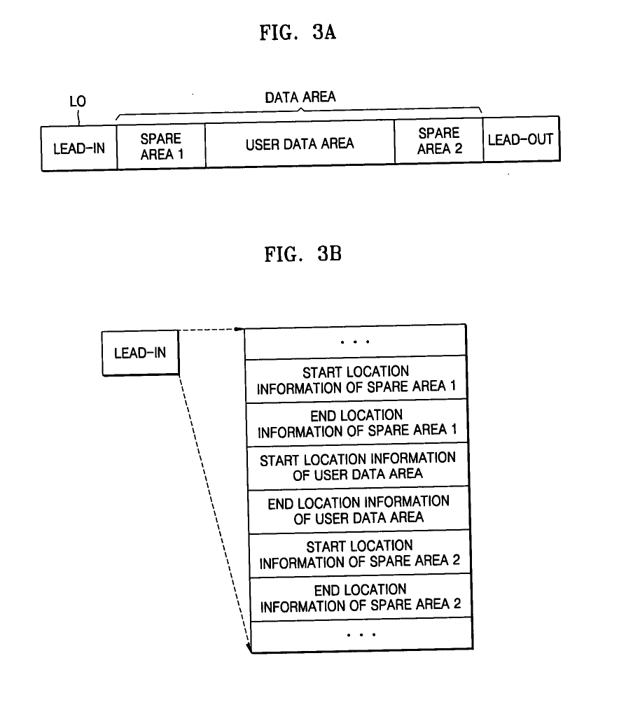

FIGS. 3A and 3B illustrate structures of a single recording layer disc according to an embodiment of the present invention.

Referring to FIG. 3A, the disc 100 is a single recording layer disc having one recording layer L0, and includes a lead-in area, a data area and a lead-out area. The lead-in area is disposed on the inner circumference side of the disc 100 and the lead-out area is disposed on the outer circumference side. The data area is disposed between the lead-in area and the lead-out area. The data area is divided into spare area 1, user data area, and spare area 2 arranged in order from the inner circumference side. The user data area is an area in which user data is recorded. Spare areas 1 and 2 are areas to supplement loss of a recording space in the user data area caused by a defect. Each spare area 1 and 2 is set to permit compensation for defects on the disc 100 while securing a maximum data recording capacity.

Meanwhile, the location of each spare area 1 and 2 can be changed in a variety of ways, and the number of spare areas may be only one or three or more in addition to the two spare areas illustrated. That is, the location and number of the spare areas can be changed in a variety of ways.

Referring to FIG. 3B, according to an embodiment of the present invention, location information of each area disposed on the disc 100 is recorded in the lead-in area. That is, the start location information of spare area 1, the end location information of spare area 1, the start location information of the user data area, the end location information of the user data area, the start location information of spare area 2, and the end location information of spare area 2 are recorded. The location information is recorded with a physical address.

Alternatively, the start location information and the length (or the number of recording/reproducing unit blocks) of an area can be recorded. The location information of each area can also be recorded in part of the lead-out area or the data area.

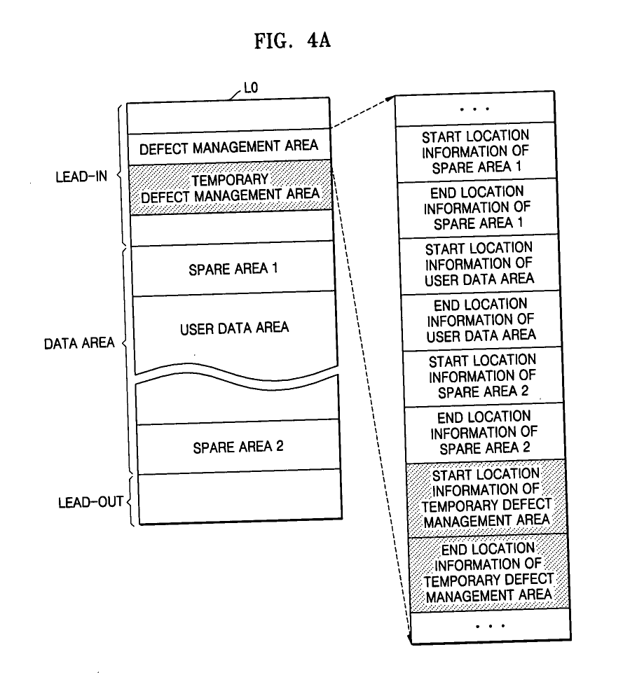

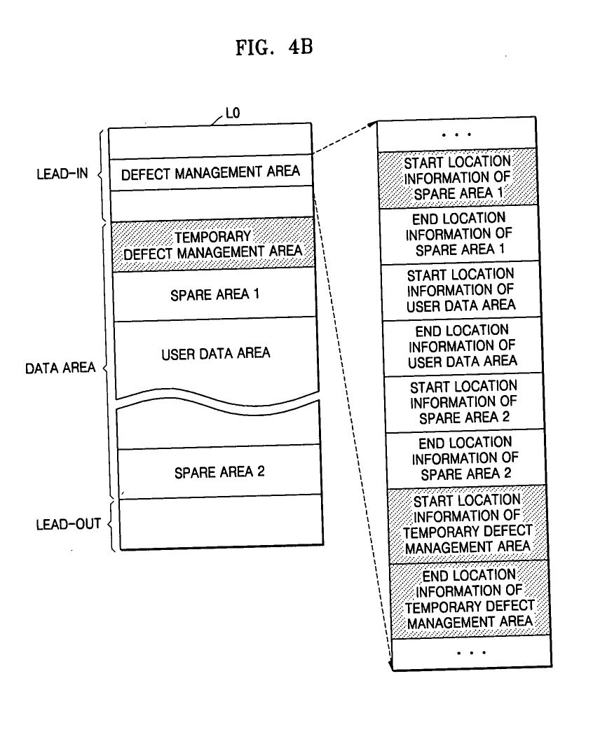

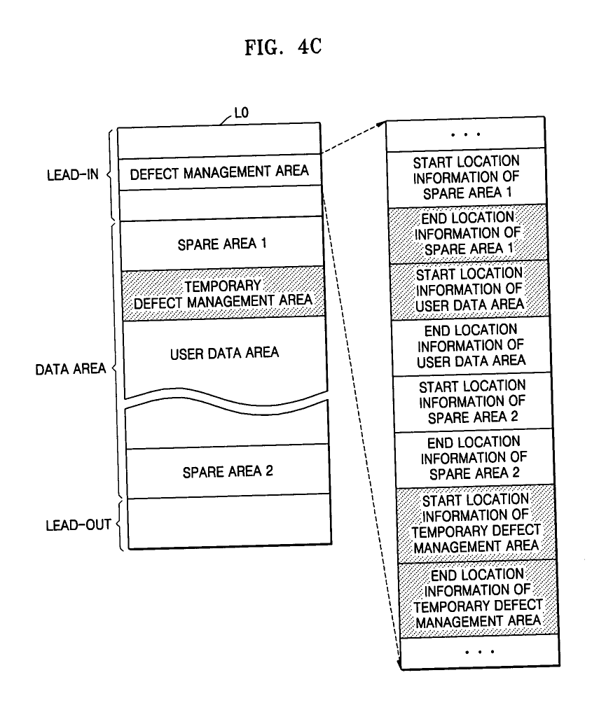

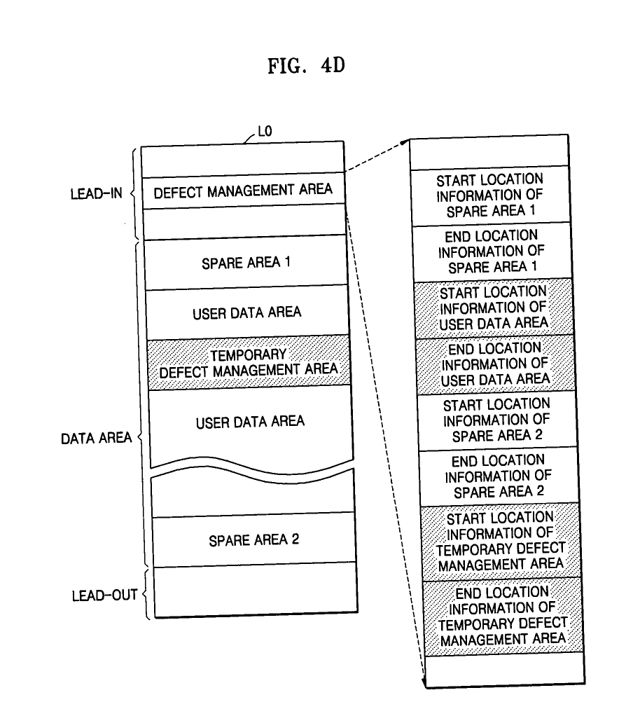

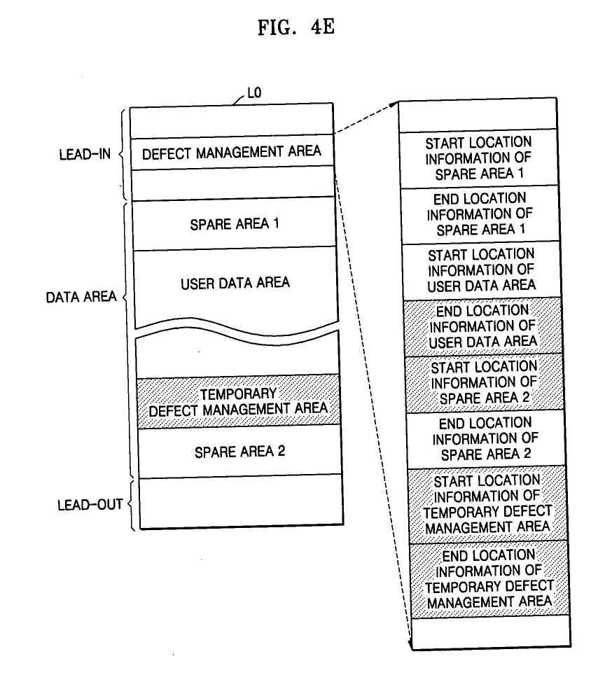

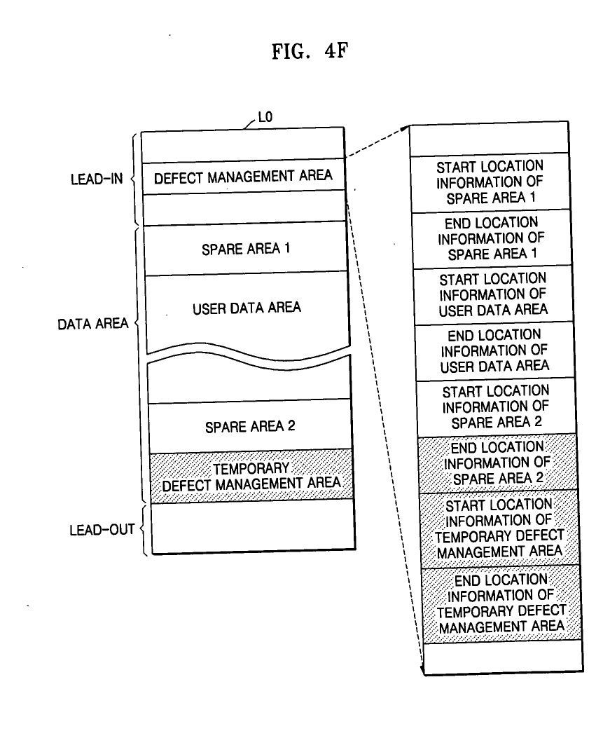

FIGS. 4A through 4F illustrate implementation examples of the disc of FIGS. 3A and 3B, and are showing a variety of cases in which a new area is allocated. The shaded area in recording layer L0 indicates a newly allocated area, and the shaded areas in the data structure of the defect management area indicate new location information of a newly recorded area or an updated area.

Referring to FIGS. 4A through 4F, in the lead-in area of the disc, the start location information of spare area 1, the end location information of spare area 1, the start location information of the user data area, the end location information of the user data area, the start location information of spare area 2, and the end location information of spare area 2 are recorded.

The disc drive according to an embodiment of the present invention can recognize spare areas 1 and 2, and the user data area by referring to location information read from, for example, the defect management area of the lead-in area.

Referring to FIG. 4A, when in order to perform defect management, the disc drive allocates a temporary defect management area as a new area in the lead-in area, the disc drive records new location information of the temporary defect management area on the disc 100. When finalizing is performed, the information is recorded in the defect management area as management information for managing defects. Meanwhile, since there are no changes in the boundaries of spare areas 1 and 2, and the user data area, updating the location information of each existing area is not needed.

Referring to FIG. 4B, since when the disc drive allocates a temporary defect management area between the lead-in area and spare area 1, the boundary of spare area 1 is changed, and the location information on the boundary is updated. In the present embodiment, since the disc 100 is a write once disc, the changed location information is again recorded. In the case of a rewritable disc, overwrite is possible. When both the boundaries of the lead-in area and spare area 1 are changed, the changed location information is all updated.

Referring to FIG. 4C, since when the disc drive allocates a temporary defect management area between spare area 1 and the user data area, thus changing the boundary between spare area 1 and the user data area, the location information on the boundary is updated.

Referring to FIG. 4D, when the disc drive allocates a temporary defect management area in the user data area, the location information indicating the boundaries of the user data area is updated.

Referring to FIG. 4E, when the disc drive allocates a temporary defect management area between the user data area and spare area 2, the location information indicating the changed boundaries of the user data area and spare area 2 are updated.

Referring to FIG. 4F, when the disc drive allocates a temporary defect management area between spare area 2 and the lead-out area, the location information indicating the changed boundary of the spare area 2 is updated.

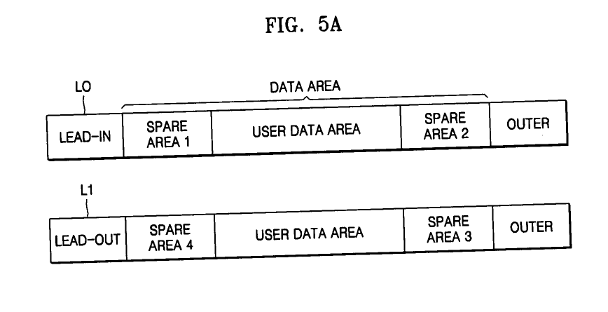

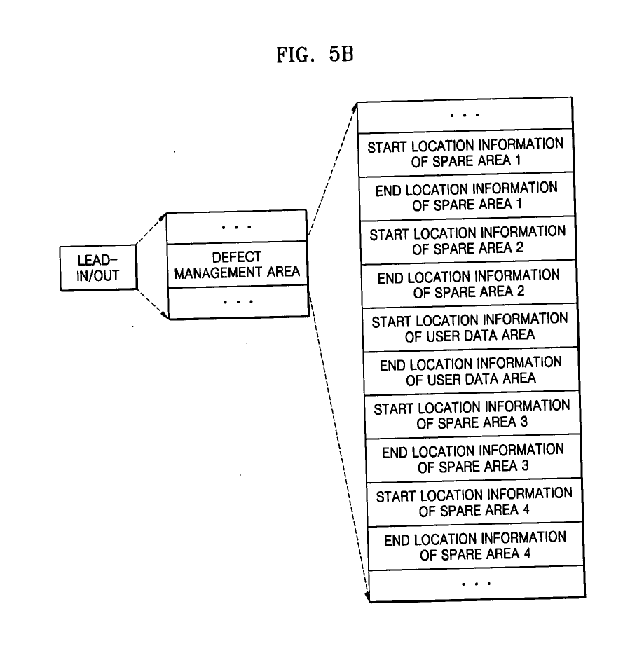

FIGS. 5A and 5B illustrate structures of a double recording layer disc according to an embodiment of the present invention.

Referring to FIG. 5A, the disc is a double recording layer disc having recording layers L0 and L1. In recording layer L0, a lead-in area, a data area, and an outer area are disposed in sequential order from the inner circumference side to the outer circumference side, and in recording layer L1, an outer area, a data area, and a lead-out area are disposed in order from the outer circumference side to the inner circumference side. Unlike the single recording layer disc of FIG. 3A, the lead-out area is also disposed on the inner circumference side of the disc the same as the lead-in area. That is, the recording path for recording data is an opposite track path (OTP) which begins from the lead-in area of recording layer L0 and extends to the outer area of recording layer L0, and then from the outer area of recording layer L1 to the lead-out area of recording layer L1. All four spare areas, spare areas 1 through 4, including each two in recording layers L0 and L1, respectively, are disposed one on each side of a user data area.

Referring to FIG. 5B, according to an embodiment of the present embodiment, in the lead-in area and lead-out area, location information of each area allocated on the disc 100 is recorded. That is, the start location information of spare area 1, the end location information of spare area 1, the start location information of spare area 2, and the end location information of spare area 2, the start location information of the user data area, the end location information of the user data area, the start location information of spare area 3, the end location information of spare area 3, the start location information of spare area 4, the end location information of spare area 4, are recorded. In the present embodiment, the location information is recorded with a physical address.

Alternatively, the start location information and the length (or the number of recording/reproducing unit blocks) of an area can be recorded. The location information of each area can also be recorded in part of the outer or the data area.

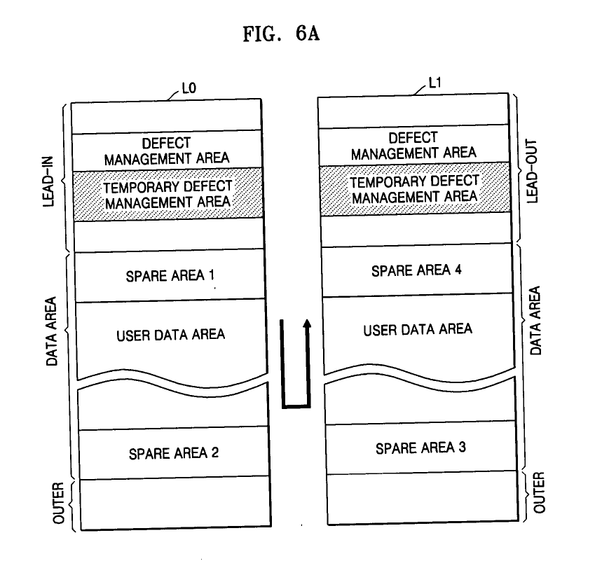

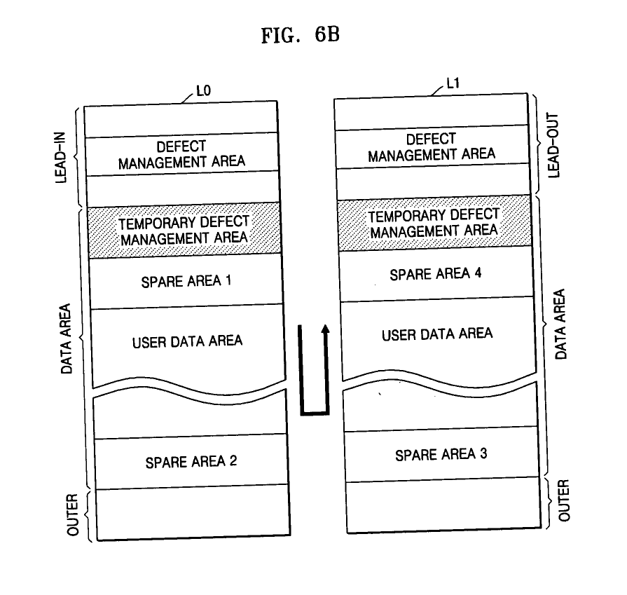

FIGS. 6A and 6B illustrate implementation examples of the dual layer disc of FIGS. 5A and 5B, and are showing a variety of cases in which a new area is allocated.

Referring to FIG. 6A, in the lead-in area (and/or the lead-out area), a defect management area is disposed. Alternatively, the defect management area can be disposed on the outer area.

As described with reference to FIG. 5B, in the defect management area, the start location information of spare area 1, the end location information of spare area 1, the start location information of spare area 2, and the end location information of spare area 2, the start location information of the user data area, the end location information of the user data area, the start location information of spare area 3, the end location information of spare area 3, the start location information of spare area 4, the end location information of spare area 4, are recorded. Accordingly, the disc drive reads the information and recognizes each area allocated on the disc.

Referring to FIG. 6A, when the disc drive allocates a temporary defect management area in the lead-in area, the disc drive records the location information of the temporary defect management area on the disc 100. In the present embodiment, when finalizing is performed, the information is recorded in the defect management area as management information for managing defects. Meanwhile, since there are no changes in the boundaries of spare areas 1 through 4, and the user data area, updating corresponding location information of each area is not needed.

Referring to FIG. 6B, when the disc drive allocates a temporary defect management area between the lead-in area and spare area 1 in recording layer L0 and allocates a temporary defect management area between the lead-out area and spare area 4 in recording layer L1, the boundaries of spare areas 1 and 4 are changed, and therefore the location information on the boundaries is updated. In the present embodiment, since the disc 100 is a write once disc, the changed location information is again recorded. In case of a rewritable disc, overwrite is possible.

In the remaining cases, the temporary defect management area is processed in the same manner as described with reference to FIGS. 4C through 4F.

When the disc drive allocates a temporary defect management area between spare area 1 and the user data area in recording layer L0 and a temporary defect management area between spare area 4 and the user data area in recording layer L1, the boundaries of spare areas 1 and 4, and user data areas are changed, and therefore the location information of spare areas 1 and 4 and the user data areas are updated.

When the disc drive allocates a temporary defect management area in the user data area both in recording layers L0 and L1, the boundaries of the user data areas are changed and therefore the location information is updated.

When the disc drive allocates a temporary defect management area between the user data area and spare area 2 in recording layer L0 and allocates a temporary defect management area between the user data area and spare area 3 in recording layer L1, the boundaries of spare areas 2 and 3, and the user data areas are changed, and therefore, the respective corresponding location information is updated.

When the disc drive allocates a temporary defect management area between spare area 2 and the outer area in recording layer L0 and allocates a temporary defect management area between spare area 3 and the outer area, the boundaries of spare areas 2 and 3 are changed and therefore, the respective corresponding location information is updated.

A method of managing a defect on the disc by the disc drive using the temporary defect management area allocated as described above will now be explained in more detail.

In the present embodiment, defect management is performed according to a linear replacement method. As a result of defect management, temporary management information from a temporary defect management area (TDMA) is divided into temporary defect information stored in a temporary defect list (TDFL) and temporary defect management information stored in a temporary defect structure (TDDS). The temporary defect information has information indicating the location of an area in which a defect occurs, and information indicating a newly replacing area. The temporary defect management information is information for managing temporary defect information, and includes information indicating the location in which temporary defect information is recorded.

In the present embodiment, temporary defect information and temporary defect management information to be recorded in a temporary defect management area are recorded according to a recording cycle, that is, the information items are recorded when data is recorded in the user data area corresponding to a predetermined number of clusters, or whenever one writing operation is performed and then verification is performed, or when a recording operation is finished.

Temporary defect information and temporary defect management information recorded most recently, that is, information updated and recorded most recently, are recorded in a defect management area when finalizing is performed. The reason why the information is recorded again in the defect management area is to improve reliability and access times.

For example, when no more data is to be recorded on a disc (i.e., when finalizing is performed), moving the temporary defect information and the temporary defect management information that have been updated and recorded many times, into the defect management area provides the advantage that the disc drive can read information recorded on the disc more quickly in the future, and recording defect management information in a plurality of places provides the advantage of improving reliability of information.

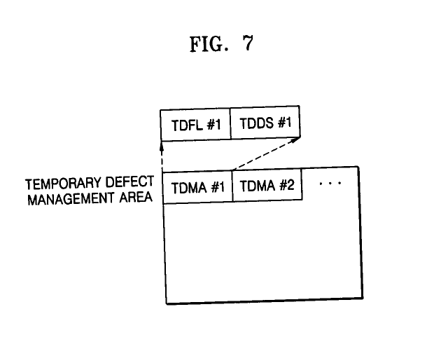

FIG. 7 illustrates the data structure in a temporary defect management area according to an embodiment of the present invention.

Referring to FIG. 7, in the temporary defect management, temporary defect information and temporary defect management information corresponding to each other are recorded. That is, in the temporary defect management area, temporary management information TDMA #1, #2, . . . , are sequentially recorded. In temporary defect information TDMA #1, temporary defect management information TDDS #1 and temporary defect information TDFL #1 corresponding to each other are recorded, and in temporary defect information TDMA #2, temporary defect management information TDDS #2 and temporary defect information TDFL #2 corresponding to each other are recorded (not shown).

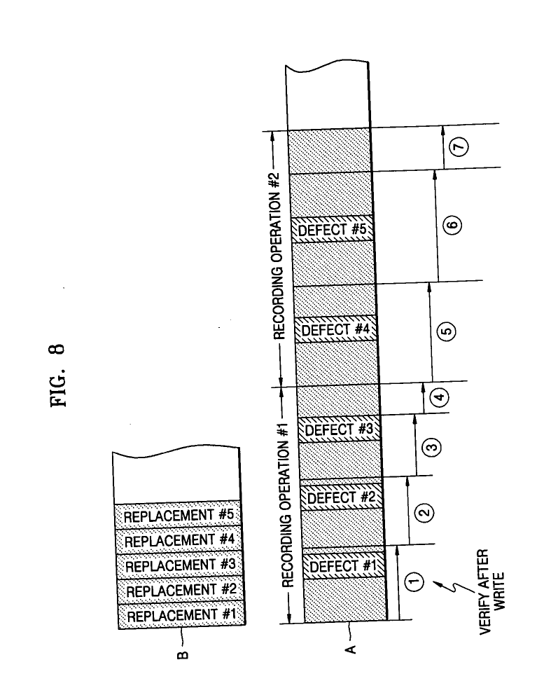

FIG. 8 is a reference diagram explaining in detail a process for recording data in a user data area and a spare area according to an embodiment of the present invention.

Referring to FIG. 8, A indicates a user data area, and B indicates a spare area. In each of the user data area A and the spare area B, there are a plurality of physical sectors (not shown) to which physical sector numbers are sequentially allocated. A logical sector number is allocated to at least one physical sector unit. However, the logical sector number is allocated by including a replacement area of the spare area B excluding a defect area occurring in the user data area A in which a defect occurs. Even though it is assumed that the size of a physical sector and that of a logical sector are identical, if a defect area occurs, the physical sector number and the logical sector number will become different.

Each of intervals \textcircled{1} through \textcircled{7} indicates a unit in which a write and verify operation is performed. The disc drive records user data in interval \textcircled{1} and then, returning to the first part of interval (D, confirms whether data is correctly recorded or a defect occurs. If a part in which a defect occurs is found, the part is designated as a defect area. For example, defect #1 is designated as a defective area in which a defect was found. Also, the disc drive records data recorded in the defective area defect #1 again in the spare area B. A part in which data recorded in the defective area defect #1 is again recorded is referred to as replacement #1.

Again, the disc drive records user data in interval \textcircled{2} and then, returning to the first part of interval \textcircled{2}, confirms whether data is correctly recorded or a defect occurs. If a part in which a defect occurs is found, the part is designated as defect #2. In the same manner, replacement #2 corresponding to defect #2 is generated.

In interval \textcircled{3}, defect #3 that is a defect area and replacement #3 are generated. In interval \textcircled{4}, a part in which a defect occurs is not found and there is no defect area.

If the end of recording operation #1 is expected after recording and verifying data through interval \textcircled{4} (e.g., if the user pushes the eject button or recording user data allocated to the recording operation is completed), the disc drive records temporary defect information #1, that is, information on defects #1, #2, and #3 that are defect areas occurring from interval \textcircled{1} to interval \textcircled{4}, in a temporary defect management area as TDFL #1. Also, management information for managing TDFL #1 is recorded as TDDS #1 in the temporary defect management area.

If recording operation #2 begins, data is recorded in intervals \textcircled{5} through \textcircled{7} in the same manner and defects #4 and #5 and replacements #4 and #5 are generated. If the end of recording operation #2 is expected, the disc drive records information on defects #4 and #5 as temporary defect information #2, that is, TDFL #2, while further recording accumulatively information recorded in temporary defect information #1. In the same manner, defect management information for managing TDFL #2 is recorded as TDDS #2 in the temporary defect management area.

A method to obtain flexibility of area allocation according to an embodiment of the present invention on the basis of the structures described above will now be explained.

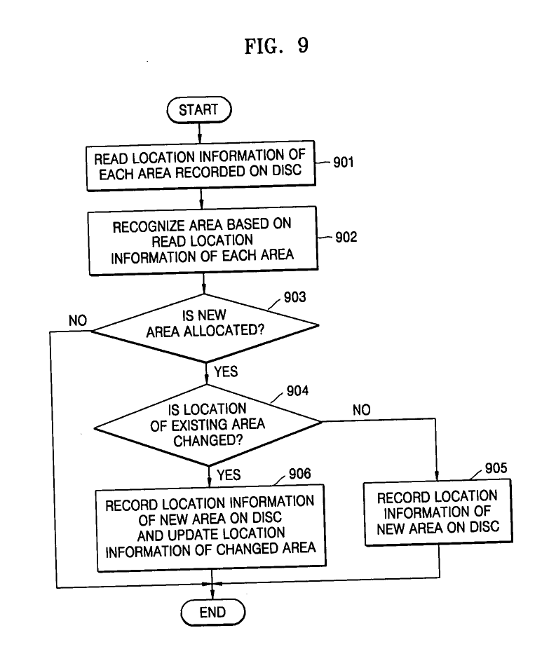

FIG. 9 is a flowchart of the operations performed by a method to obtain flexibility of area allocation according to an embodiment of the present invention.

Referring to FIG. 9, if the disc 100 is loaded, the disc drive reads location information of each area recorded on the disc 100 in operation 901, and by referring to only read location information of each area, recognizes each area in operation 902. When a new area is allocated in operation 903 and existing area boundaries are unaffected, the location information of the new area is recorded on the disc 100 in operation 905. If the location of an existing area is changed due to the allocation of the new area in operation 904, the location of the new area is recorded on the disc and at the same time, the location information of the changed area is again recorded to update the location in operation 906.

Meanwhile, the method to obtain flexibility in area allocation on a disc described above can be implemented as a computer program. Codes and code segments forming the program can be easily inferred by the programmers in the technology field of the present invention. Also, the program is stored in computer readable media, and read and executed by a computer to implement the filtering method. The computer readable media includes magnetic recording media, optical recording media and carrier wave media.

According to aspects of the present invention as described above, by recording location information of each area on the disc, the disc drive becomes able to recognize areas disposed on discs with different formats and a variety of different areas. Furthermore, when a new area is allocated, the location information on the allocated area is recorded and if the location of an existing area is changed due to the newly allocated area, the location information of the existing area is updated to reflect the change and recorded on the disc such that the flexibility of allocating an area is obtained.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method to obtain flexibility of allocating areas on a disc, comprising:
recording on the disc, location information corresponding to each area disposed on the disc.

2. The method of claim 1, wherein the recording of the location information comprises recording the location information corresponding to each of a user data area and a spare area disposed on the disc.

3. The method of claim 1, wherein the location information is recorded in at least one of a lead-in area or a lead-out area of the disc.

4. The method of claim 1, wherein the recording of the location information comprises recording the location information in a defect management area disposed in at least one of a lead-in area or a lead-out area of the disc.

5. A method to obtain flexibility of allocating areas on a disc, comprising:
reading from the disc, location information of each area disposed on the disc; and
recognizing each area disposed on the disc based on the read location information.

6. The method of claim 5, wherein the reading the location information includes reading the location information of a user data area and a spare area disposed on the disc.

7. The method of claim 5, further comprising:
allocating a new area; and
recording new location information of the allocated new area on the disc.

8. The method of claim 7, further comprising:
recording changed location information on the disc when the location information of an existing one of the areas is changed by the allocated new area.

9. An apparatus, comprising:
a writing/reading unit recording data on and/or reading data from a disc; and
a control unit controlling the writing/reading unit to record on the disc location information corresponding to each of a lead-in area, a user data area, a spare area, and a lead-out area disposed on the disc.

10. The apparatus of claim 9, wherein the control unit controls the writing/reading unit to record the location information in at least one of the lead-in area or the lead-out area.

11. The apparatus of claim 9, wherein the control unit controls the writing/reading unit to record the location information in a defect management area.

12. An apparatus, comprising:
a writing and/or reading unit reading location information corresponding to each area disposed on a disc, from the disc; and
a control unit recognizing each area disposed on the disc based on the read location information.

13. The apparatus of claim 12, wherein the control unit controls the writing and/or reading unit to read from the disc location information to recognize each of a user data area and a spare area disposed on the disc.

14. The apparatus of claim 12, wherein the control unit controls the writing and/or reading unit to record new location information corresponding to a new area on the disc when a new area is allocated.

15. The apparatus of claim 12, wherein when a temporary defect management area is allocated by the control unit, the control unit controls the writing and/or reading unit to record the location information of the allocated temporary defect management area on the disc.

16. The apparatus of claim 14, wherein when the location of an existing area is changed by the new area allocation the control unit controls the writing and/or reading unit to record the changed location information on the disc.

17. A single recording layer disc for use in a disc drive in which a lead-in area, a data area and a lead-out area are disposed and in the data area, at least one spare area and a user data area are disposed, wherein location information to recognize each of the at least one spare area and the user data area is recorded, in at least one of the lead-in area, the data area, or the lead-out area, and the disc drive recognizes the at least one spare area and the user data area by referring to the location information.

18. A disc having double recording layers for use with a disc drive, including a first recording layer in which a lead-in area, a first data area having at least one first spare area, and a first outer area are disposed, and a second recording layer in which a second outer area, a second data area having at least one second spare area, and a lead-out area are disposed, wherein location information to recognize each of the at least one first and second spare areas and the first and second data areas is recorded in at least one of the lead-in area, the lead-out area, the first outer area or the second outer area, and the disc drive recognizes the at least one first and second spare areas and the first and second data areas by referring to the location information.

19. A method of allocating areas on an information storage medium, comprising:
determining a number of different areas to be allocated on the information storage medium;
allocating portions of the information storage medium to each of the number of different areas; and
recording location information corresponding to the allocated portions of the information storage medium for each of the number of different areas.

20. An apparatus, comprising:
an optical pickup recording and/or reproducing data on/from recording layers of an information storage medium; and
a controller controlling the recording and/or reproducing of the data, wherein the recording of the data comprises allocating areas on the recording layers of the information storage medium and recording location information designating each of the allocated areas in a defect management area of the recording layers and recording the data in selected allocated areas using the location information, and the reproducing of the data comprises reading the location information such that the data stored in each of the allocated areas may be reproduced based on the read location information.
